(19) United States
(12) Patent Application Publication
(10) Pub. No.: US 2014/0123907 A1
(43) Pub. Date: May 8, 2014

(54) Interchangeable Paneled Birdhouses

(71) Applicant: Tammy James, Broken Bow, OK (US)

(72) Inventor: Tammy James, Broken Bow, OK (US)

(21) Appl. No.: 14/055,134

(22) Filed: Oct. 16, 2013

Related U.S. Application Data
(60) Provisional application No. 61/723,489, filed on Nov. 7, 2012.

(51) Int. Cl. A01K 31/00

(52) U.S. Cl. CPC A01K 31/00
USPC 119/429; 119/428

(57) ABSTRACT

A decorative birdhouse device is disclosed that provides birds with shelter from the elements and enables users to easily change the birdhouse design. The decorative birdhouse device comprises a base component, multiple channel sections, at least one side panel component, and a roof secured together. The base component comprises a bottom section, with the channel sections being secured to the bottom section of the base component. Furthermore, the channel sections comprise one or more channels sized to accept a side panel component. A plurality of side panel components are disposed in the one or more channels to form a front, a rear, and two side walls on the base component. The side panel components can also comprise at least one continuous opening for allowing a bird to enter the interior cavity of the birdhouse device.

### CROSS-REFERENCE

This application claims priority from Provisional Patent Application Ser. No. 61/723,489 filed Nov. 7, 2012.

### BACKGROUND

Many people like to change their yard or interior décor to correspond with holidays, seasons, sports or simply a new motif. There may be birdhouses available to suit each of these design schemes, but none encompasses all of them. Accordingly, a person may spend a lot of money building a collection of birdhouses to find one for each desired theme or motif. Such a collection of birdhouses is not only costly, but also requires excessive storage space and can be time consuming to install/uninstall. A versatile solution is needed.

The present invention provides birds with shelter from the elements, and enables users to easily change the design to suit décor, celebrate a holiday or season, support a sports team and more. The birdhouse device utilizes solar-powered light panels to create a nighttime display, and features separate interior chambers so birds are not disturbed by the lights. The device also incorporates a food dispenser to prevent food within the birdhouse from being spilled or wasted. Users can easily assemble and alternate the birdhouse designs, making the birdhouse device ideal for homeowners, renters, children, etc.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a decorative birdhouse device that provides birds with shelter from the elements and enables users to easily change the birdhouse design to suit their décor, celebrate a holiday or season, or support a sports team, etc. The decorative birdhouse device comprises a base component, multiple channel sections, and at least one side panel component secured together to form the device. The base component comprises a bottom section and the channel sections are secured to the bottom section of the base component.

Furthermore, the channel sections comprise one or more channels extending substantially along the length of the channel sections, which are sized to accept a side panel component. Specifically, the side panel components are disposed in the one or more channels to form walls on the base component. Typically, a plurality of side panel components are utilized, with the side panel components being disposed in the one or more channels to form a front, a rear, and two side walls on the base component. The side panel components can also comprise at least one continuous opening for allowing a bird to enter the interior cavity of the birdhouse device. Additionally, the decorative birdhouse device comprises a roof removably secured to at least one of the channel sections.

In a preferred embodiment, the decorative birdhouse device can comprise a solar light system secured to any suitable place on the birdhouse device. Furthermore, the side panel components can comprise a plurality of pin holes drilled in a predetermined design that can be illuminated via an external light source, such as the solar light system. Additionally, the birdhouse can comprise at least one wall component that secures to at least one of the side panel components and segments the interior cavity of the birdhouse device into compartments. Further, the decorative birdhouse device comprises a food dispenser secured to any suitable place on the birdhouse. In another embodiment, the channel sections can be inclined at an angle to the base component, such that the ends of the channel sections mate to form an apex of the roof.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the decorative birdhouse device in accordance with the disclosed architecture.

FIG. 2 illustrates an exploded perspective view of the decorative birdhouse device in accordance with the disclosed architecture.

FIG. 3 illustrates a perspective view of the decorative birdhouse device with a new design on one of the side panel components in accordance with the disclosed architecture.

FIG. 4 illustrates a perspective view of the decorative birdhouse device lit by the solar light system in accordance with the disclosed architecture.

FIG. 5 illustrates a perspective view of various embodiments of the birdhouse device in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof It may be evident, however, that the innovation can be practiced without these specific details. In other instances, well-known structures and devices are shown in block diagram form in order to facilitate a description thereof.

The present invention provides birds with shelter from the elements, and enables users to easily change the design to suit décor, celebrate a holiday or season, support a sports team and more. The birdhouse device may include solar-powered light panels to create a nighttime display, and features separate interior chambers so birds are not disturbed by the lights. The device also incorporates a food dispenser to prevent food within the birdhouse from being spilled or wasted. Users can easily assemble and alternate the birdhouse designs, making the birdhouse device ideal for companies, homeowners, renters, children, etc.

The disclosed decorative birdhouse device comprises a base component, multiple channel sections, a plurality of side panel components, and a roof secured together. The base component comprises a bottom section with the channel sections being secured to the bottom section of the base component. Furthermore, the channel sections comprise one or more channels extending substantially along the length of the channel sections and sized to accept a side panel component. Typically, a plurality of side panel components are disposed in the one or more channels to form a front, a rear, and two side walls on the base component. The side panel components can also comprise at least one continuous opening for allowing a bird to enter the interior cavity of the birdhouse device.

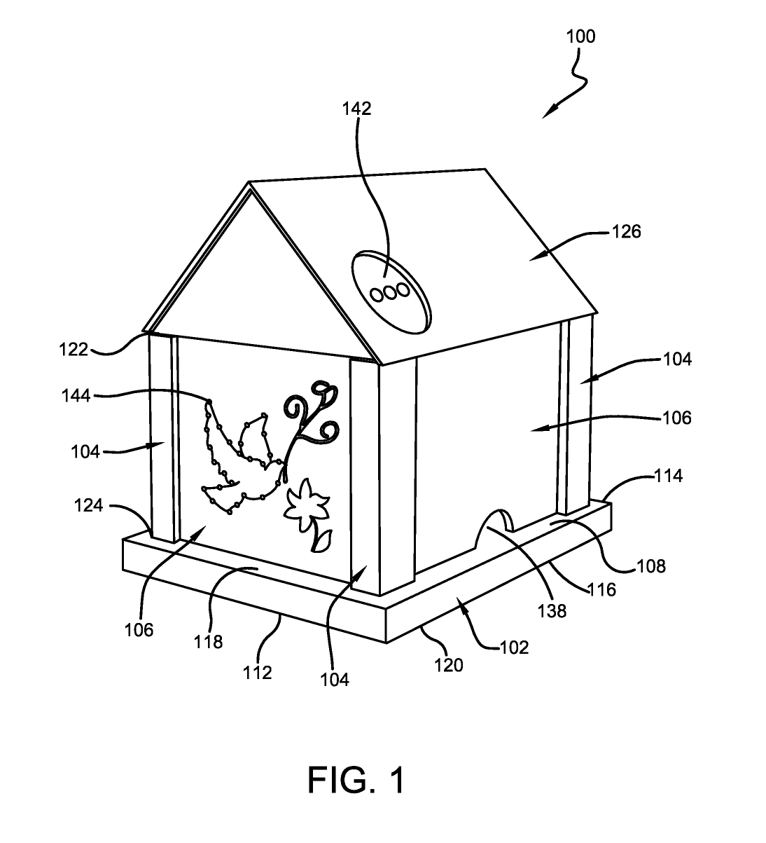

Referring initially to the drawings, FIGS. 1-3 illustrate the decorative birdhouse device 100 that provides birds with shelter from the elements and enables users to easily change the birdhouse design to suit their décor, celebrate a holiday or season, or support a sports team or company, etc. The decorative birdhouse device 100 comprises a base component 102, multiple channel sections 104, and a plurality of side panel components 106 removably secured together (as shown in FIG. 1).

The base component 102 comprises a bottom section 108. Typically, the base component 102 can be any suitable shape as is known in the art without affecting the overall concept of the invention, such as rectangular, square, circular, oval, triangular, etc. The base component 102 would generally be constructed of plywood, homogeneous plastics, such as polyvinyl chloride (PVC), acrylonitrile butadiene styrene (ABS), polycarbonate (PC), etc., composite polymers, or recycled material, though any other suitable material may be used to manufacture the base component 102 as is known in the art without affecting the overall concept of the invention, as long as the material is generally weather resistant.

The base component 102 can also comprise a variety of colors and designs to suit user and manufacturing preference. While the shape and size of the base component 102 may vary greatly depending on the wants and needs of a user, the base component 102 is approximately between 11 and 12 inches long as measured from a first end 112 to a second end 114, and approximately between 11 and 14 inches wide as measured from opposing sides 116, and approximately between ⅞ and 1½ inches thick as measured from a front surface 118 to a back surface 120.

The decorative birdhouse device 100 further comprises multiple channel sections 104 which are secured to the bottom section 108 of the base component 102. The channel sections 104 are secured to the bottom section 108 via any suitable securing means as is known in the art, such as nailing, gluing, hardware, fasteners, etc. The channel sections 104 would generally be constructed of the same material as the base component 102, such as plywood, homogeneous plastics, such as polyvinyl chloride (PVC), acrylonitrile butadiene styrene (ABS), polycarbonate (PC), etc., composite polymers, or recycled material, though any other suitable material may be used to manufacture the channel sections 104 as is known in the art without affecting the overall concept of the invention, as long as the material is generally weather resistant.

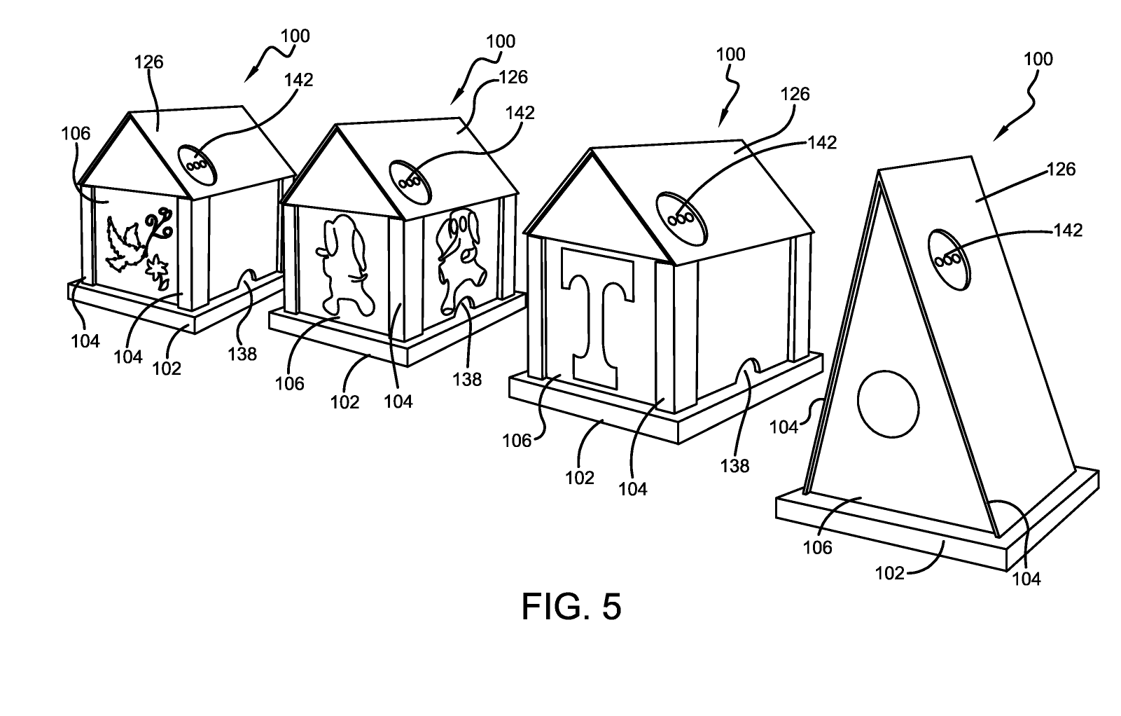

The channel sections 104 can also comprise a variety of colors and designs to suit user and manufacturing preference. While the shape and size of the channel sections 104 may vary greatly depending on the wants and needs of a user, the channel sections 104 are approximately between 5 and 10 inches long as measured from a first end 122 to a second end 124. Further, the channel sections 104 can be any suitable orientation depending on the wants and needs of a user, such as generally vertical or inclined at an angle to the base component 102, etc. (as shown in FIG. 5). If inclined at an angle to the base component 102, the channel sections 104 will mate at the first ends 122 to form an apex of the roof 126.

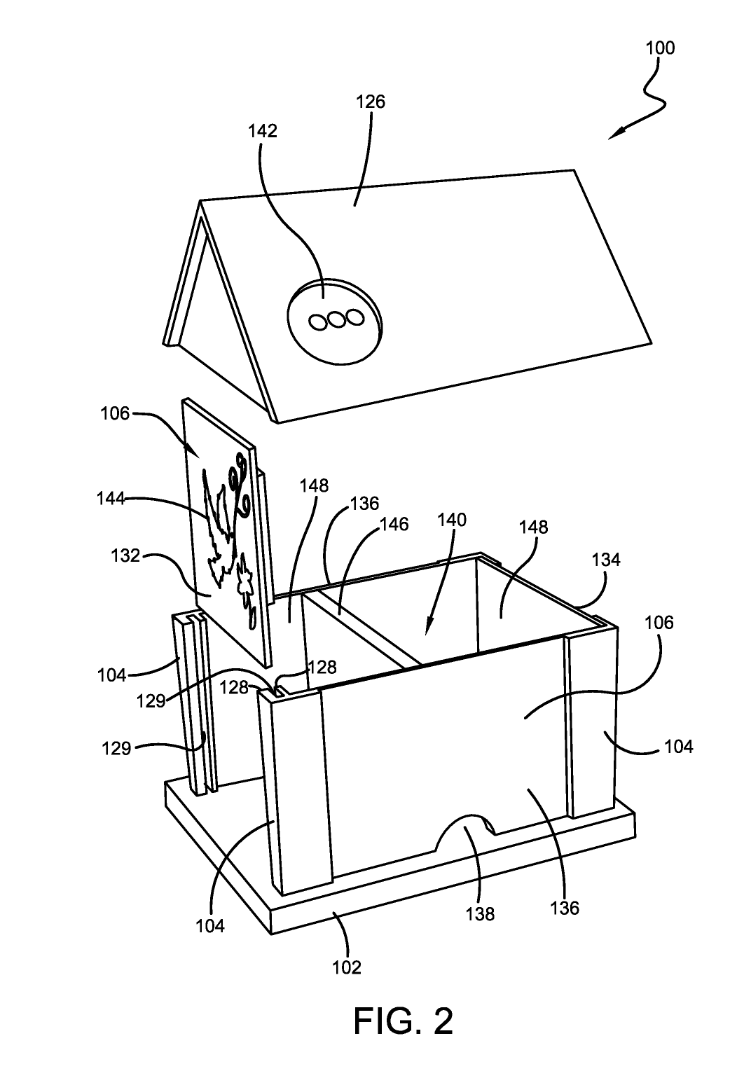

Furthermore, the channel sections 104 comprise one or more channels 129 that are sized to accept a side panel component 106. Specifically, the one or more channels 129 extend substantially along the length of the channel sections 104, from a first end 122 to a second end 124. A side panel component 106 would then be inserted in these channels 129, and slid down toward the bottom section 108 of the base component 102 (as shown in FIG. 2). Typically, a plurality of side panel components 106 are utilized, with the side panel components 106 being disposed in the one or more channels 129 to form a front 132, a rear 134, and two side walls 136 on the base component 102. The channels 129 are approximately between ⅛ and ¾ inches wide as measured from opposing sides 128, but can be any suitable size as long as the channels can accept a side panel component 106.

The side panel components 106 would generally be constructed of the same material as the base component 102, such as plywood, homogeneous plastics, such as polyvinyl chloride (PVC), acrylonitrile butadiene styrene (ABS), polycarbonate (PC), etc., composite polymers, or recycled material, though any other suitable material may be used to manufacture the side panel components 106 as is known in the art without affecting the overall concept of the invention, as long as the material is generally weather resistant.

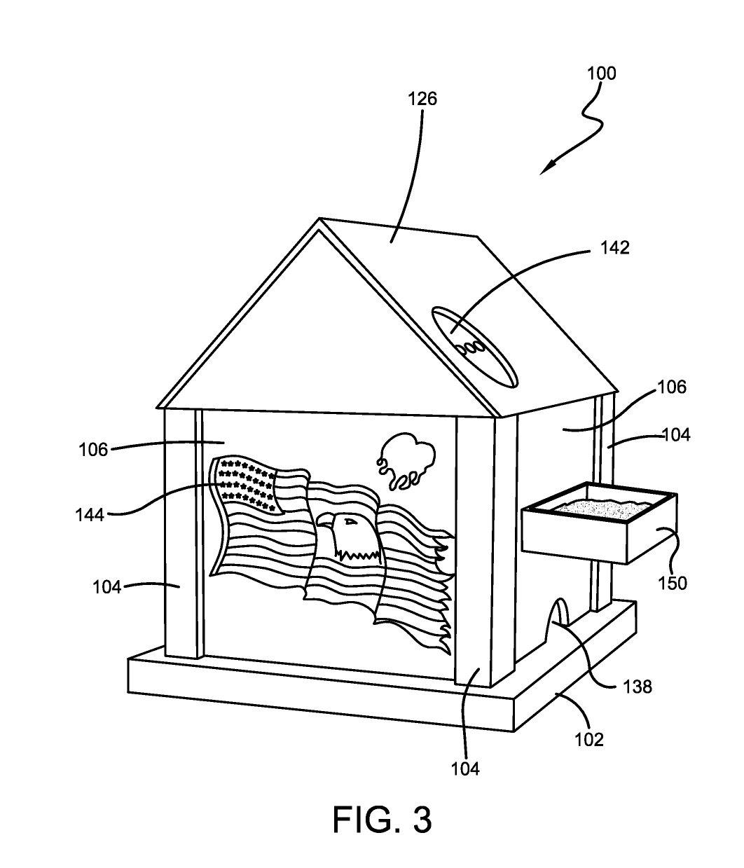

The side panel components 106 can also comprise a variety of colors, designs, or logos to suit user and manufacturing preference. Further, the shape and size of the side panel components 106 may vary greatly depending on the wants and needs of a user, as long as the side panel components 106 are able to be slid into the channels 129 of the channel sections 104. For example, the side panel components 106 can be any suitable shape as is known in the art without affecting the overall concept of the invention, such as rectangular, square, circular, oval, triangular, etc. The side panel components 106 can be easily removed by a user and interchanged with side panel components 106 depicting a different design or logo (as shown in FIG. 3). The side panel components 106 can be removed from the front or sides of the device 100, by sliding the side panel components 106 into the channels 129. The side panel components 106 can also comprise at least one continuous opening 138 therein for allowing a bird to enter the interior cavity 140 of the birdhouse 100. The continuous opening 138 can be any suitable size as is known in the art to fit different sized birds. Further, there can be multiple openings 138 of different sizes to accommodate different sizes and types of birds. Any number of the side panel components 106 can comprise a continuous opening 138 for birds to enter the interior cavity 140 of the birdhouse 100.

Additionally, the side panel components 106, roof 126, or other suitable component of the birdhouse device 100 can comprise a solar light system 142. The solar light system 142 comprises at least one solar panel (i.e., a solar cell), a solar light source, and a battery in electrical communication with each other, which illuminates the birdhouse device 100. The solar light system 142 is secured to any suitable place on the decorative birdhouse device 100, such as the side panel component 106, the roof 126, or the base component 102. Further, multiple side panel components 106 can comprise a solar light system 142 as well. Furthermore, the side panel components 106 can comprise a plurality of pin holes 144 drilled in a predetermined design that can be illuminated via an external or internal light source. The pin holes 144 can be drilled in any suitable shape and design to suit user and manufacturing preference. The pin holes 144 can be illuminated via an external or internal light source, such as solar lights, or electrical lights. Typically, the solar light system 142 acts to illuminate the pin holes 144.

The decorative birdhouse device 100 further comprises at least one wall component 146 that secures to at least one of the side panel components 106, or is secured adjacent to the side panel components 106 and segments (or sections off) the interior cavity 140 of the birdhouse 100 into compartments 148 (as shown in FIG. 2). This allows the solar light system 142 to be activated and illuminated, but yet does not disturb the birds that are inside the interior cavity 140. The wall components 146 are secured to the side panel components 106 via any suitable securing means as is known in the art, such as nailing, gluing, hardware, fasteners, etc.

Additionally, the decorative birdhouse device 100 comprises a roof 126 removably secured to at least one of the channel sections 104. The roof 126 can be any suitable shape and size as is known in the art, as long as the roof 126 adequately covers the interior cavity 140 of the birdhouse device 100, protecting the birds within from rain, snow, sleet, and other weather conditions. The roof 126 is removably secured to the channel sections 104 via any suitable securing means such as hardware, fasteners, hinges, etc. However, the roof 126 is able to be removed as needed, allowing access to the interchangeable side panel components 106 and to the interior cavity 140 of the birdhouse device 100. Furthermore, the decorative birdhouse device 100 can comprise a clean out tray, or other suitable means for cleaning the device 100.

Further, the decorative birdhouse device 100 comprises a food dispenser 150 (or feeder). The food dispenser 150 can be secured to any suitable place on the decorative birdhouse device 100, such as the side panel components 106, the roof 126, or the base component 102, and can be positioned inside or outside of the decorative birdhouse device 100. The food dispenser 150 can be covered by poly methyl methacrylate or another suitable weather-resistant, transparent thermoplastic. The food dispenser 150 can be designed to distribute the food (i.e., seeds) slowly in order to avoid spilling and waste, and can comprise a clean out tray for easy cleaning. However, the birds may trigger the food dispenser 150 to dispense more food by pecking on the transparent covering.

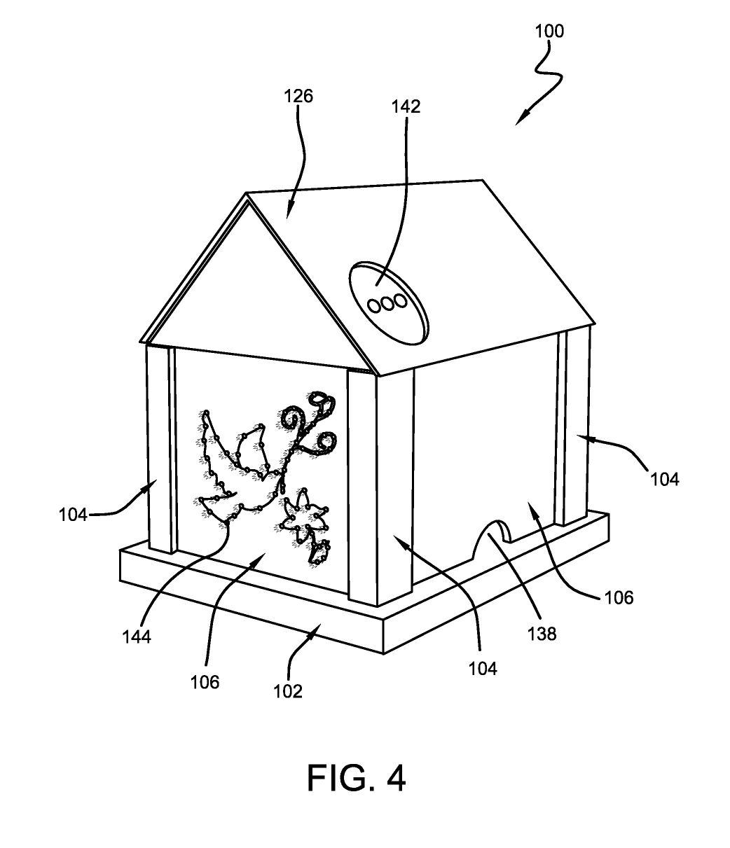

FIG. 4 illustrates the decorative birdhouse device 100 lit by the solar light system 142. As stated supra, the side panel components 106 or roof 126 can comprise a solar light system 142. The solar light system 142 comprises at least one solar panel (i.e., a solar cell), a solar light source, and a battery in electrical communication with each other, which illuminates the birdhouse 100. The solar light system 142 is secured to at least one side panel component 106, however, multiple side panel components 106 can comprise a solar light system 142 as well.

Furthermore, the side panel components 106 can comprise a plurality of pin holes 144 drilled in a predetermined design that can be illuminated via an external light source. The pin holes 144 can be drilled in any suitable shape and design to suit user and manufacturing preference. The pin holes 144 can be illuminated via an external or internal light source, such as solar lights, or electrical lights. Typically, the solar light system 142 acts to illuminate the pin holes 144 (as shown in FIG. 4).

FIG. 5 illustrates various embodiments of the birdhouse device 100. As stated supra, the decorative birdhouse device 100 comprises a base component 102, multiple channel sections 104, and at least one side panel component 106 secured together. The base component 102 comprises a bottom section 108 with a channel section 104 secured to the bottom section 108 of the base component 102. Typically, the base component 102 can be any suitable shape as is known in the art without affecting the overall concept of the invention, and the channel sections 104 can comprise a variety of colors and designs to suit user and manufacturing preference.

Further, the channel sections 104 can be any suitable orientation depending on the wants and needs of a user, such as generally vertical (see 500, 502 and 504 in FIG. 5) or inclined at an angle to the base component 102, etc. (see 506 in FIG. 5). If inclined at an angle to the base component 102, the channel sections 104 will mate at the first ends 122 to form an apex of the roof 126.

Additionally, the channel sections 104 comprise one or more channels 129 extending substantially along the length of the channel sections 104 and sized to accept one of the side panel components 106. A side panel component 106 would then be removably inserted in these channels 129. Typically, a plurality of side panel components 106 are utilized, with the side panel component 106 being disposed in the channels 129 to form a front 132, a rear 134, and two side walls 136 on the base component 102.

The side panel components 106 can comprise a variety of colors, designs, and logos to suit user and manufacturing preference. Further, the shape and size of the side panel components 106 may vary greatly depending on the wants and needs of a user. The side panel components 106 can be easily removed by a user and interchanged with side panel components 106 depicting a different design or logo, thus enabling users to easily change the birdhouse design to suit their décor, celebrate a holiday or season, or support a sports team or company, etc.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A decorative birdhouse device comprising:
a base component comprising a bottom section;
at least two generally vertically oriented channel sections secured to the bottom section of the base component;
wherein the at least two channel sections each comprise one or more channels extending substantially along a length of the at least two channel sections; and
wherein the one or more channels are sized to accept a side panel component; and
at least one side panel component disposed in the one or more channels to form a wall on the base component.

2. The decorative birdhouse device of claim 1, further comprising a roof removably secured to at least one of the at least two channel sections.

3. The decorative birdhouse device of claim 1, further comprising a plurality of side panel components, wherein each of the side panel components are disposed in the one or more channels to form a front, a rear, and two side walls on the base component.

4. The decorative birdhouse device of claim 3, further comprising at least one wall component that secures to at least one of the plurality of side panel components and segments an interior cavity of the birdhouse device into compartments.

5. The decorative birdhouse device of claim 4, wherein at least one of the plurality of side panel components comprises at least one continuous opening for allowing a bird to enter the interior cavity of the birdhouse device.

6. The decorative birdhouse device of claim 1, further comprising a solar light system.

7. The decorative birdhouse device of claim 1, further comprising a plurality of pin holes drilled into the at least one side panel component in a predetermined design, that can be illuminated via an external light source.

8. The decorative birdhouse device of claim 7, wherein the plurality of pin holes are illuminated via solar lights.

9. The decorative birdhouse device of claim 7, wherein the plurality of pin holes are illuminated via electrical lights.

10. The decorative birdhouse device of claim 1, further comprising a food dispenser.

11. A decorative birdhouse device comprising:
a base component comprising a bottom section;
at least two generally vertically oriented channel sections secured to the bottom section of the base component;
wherein the at least two channel sections each comprise one or more channels extending substantially along a length of the at least two channel sections; and
wherein the one or more channels are sized to accept a side panel component; and
a plurality of side panel components disposed in the one or more channels to form a front, a rear, and two side walls on the base component; and
a roof removably secured to the at least two channel sections.

12. The decorative birdhouse device of claim 11, further comprising a food dispenser.

13. The decorative birdhouse device of claim 11, further comprising a solar light system.

14. The decorative birdhouse device of claim 11, further comprising at least one wall component that secures to at least one of the plurality of side panel components and segments an interior cavity of the birdhouse device into compartments.

15. The decorative birdhouse device of claim 14, wherein at least one of the plurality of side panel components comprises at least one continuous opening for allowing a bird to enter the interior cavity of the birdhouse device.

16. The decorative birdhouse device of claim 11, further comprising a plurality of pin holes drilled into the at least one side panel component in a predetermined design, that can be illuminated via an external light source.

17. The decorative birdhouse device of claim 16, wherein the plurality of pin holes are illuminated via solar lights.

18. The decorative birdhouse device of claim 16, wherein the plurality of pin holes are illuminated via electrical lights.

19. A decorative birdhouse device comprising:
a base component comprising a bottom section;
at least two channel sections inclined at an angle to the base component and secured to the bottom section of the base component;
wherein the at least two channel sections each comprise one or more channels extending substantially along a length of the at least two channel sections; and
wherein the one or more channels are sized to accept a side panel component; and
at least two side panel components disposed in the one or more channels to form a front and a rear wall on the base component; and
a roof removably secured to the at least two channel sections.

20. The decorative birdhouse device of claim 19, further comprising a solar light system.
